(19) United States
(12) Patent Application Publication
(10) Pub. No.: US 2021/0362622 A1
(43) Pub. Date: Nov. 25, 2021

(54) CONTROL DEVICE, CONTROL SYSTEM, CONTROL METHOD, AND STORAGE MEDIUM

(71) Applicant: HONDA MOTOR CO., LTD., Tokyo (JP)

(72) Inventor: Shuichi Kazuno, Wako-shi (JP)

(21) Appl. No.: 17/320,248

(22) Filed: May 14, 2021

(30) Foreign Application Priority Data
May 19, 2020 (JP) 2020-087520

(51) Int. Cl. B60L 58/16; B60L 58/14; G07C 5/00

(52) U.S. Cl. CPC B60L 58/16; G07C 5/008; B60L 58/14

(57) ABSTRACT

A control device includes a communication unit configured to communicate with a management device that stores output limit information of an energy source used by a control device of a vehicle when the energy source is mounted on the vehicle, and a control unit configured to control output of the energy source on the basis of an output limit pattern based on the output limit information received by the communication unit from the management device.

### CROSS-REFERENCE TO RELATED APPLICATION

Priority is claimed on Japanese Patent Application No. 2020-087520, filed May 19, 2020, the content of which is incorporated herein by reference.

### BACKGROUND

### Field of the Invention

The present invention relates to a control device, a control system, a control method, and a storage medium.

### Description of Related Art

Batteries (secondary batteries) such as lithium ion batteries are used in electrically driven vehicles such as electric vehicles and hybrid vehicles. In order to ensure a stable supply of batteries in the future, it is thought that secondary use thereof will be more actively utilized. In the related art, a technology related to a device and a method for providing energy management and maintenance of a battery, which is to be secondarily used, through the use of a secondary service port has been disclosed (for example, see Japanese Unexamined Patent Application, First Publication No. 2013-243913).

### SUMMARY

In the related art, output control of a battery secondarily used has not been sufficiently studied.

Aspects according to the present invention are achieved in view of the problems described above, and one object of the present invention is to provide a control device, a control system, a control method, and a storage medium, by which it is possible to appropriately control the output of a battery to be secondarily used.

In order to solve the above problems and achieve the above object, the present invention employs the following aspects.

(1) A control device according to an aspect of the present invention includes a communication unit configured to communicate with a management device that stores output limit information of an energy source used by a control device of a vehicle when the energy source is mounted on the vehicle, and a control unit configured to control output of the energy source on the basis of an output limit pattern based on the output limit information received by the communication unit from the management device.

(2) In the above aspect (1), the control unit may control the output of the energy source with an output limit pattern, in which a predetermined margin is added to the output limit pattern based on the output limit information, on the basis of information on the energy source.

(3) In the above aspect (2), the control unit may select the margin on the basis of storage state information of the energy source.

(4) In the above aspects (1) to (3), the control device may further include an acquisition part configured to acquire a state of the energy source, and when the communication unit does not receive the output limit information from the management device, the control unit may control the output of the energy source mounted on the vehicle with reference to one output limit pattern of a plurality of output limit patterns with different output levels, and change the output limit pattern from an initial output limit pattern to an output limit pattern with a high output level on the basis of the acquired state of the energy source.

(5) A control system according to an aspect of the present invention includes a first electrically driven device including a first communication unit configured to transmit, to a management device, output limit information of an energy source used by a control device of a host vehicle when the energy source is mounted on the host vehicle, a second electrically driven device including a control unit configured to transmit a transmission request of the output limit information of the energy source to the management device by using a second communication unit when the energy source is mounted, and to control output of the energy source on the basis of an output limit pattern based on the output limit information received by the second communication unit from the management device, and the management device configured to store the output limit information received from the first electrically driven device, and to transmit the output limit information to the second electrically driven device when the transmission request of the output limit information is received from the second electrically driven device.

(6) A control method according to an aspect of the present invention is implemented by a computer that communicates with a management device that stores output limit information of an energy source used by a control device of a vehicle when the energy source is mounted on the vehicle, and controls output of the energy source on the basis of an output limit pattern based on the output limit information received from the management device.

(7) A non-transitory computer readable storage medium according to an aspect of the invention stores a program causing a computer to communicate with a management device that stores output limit information of an energy source used by a control device of a vehicle when the energy source is mounted on the vehicle, and control output of the energy source on the basis of an output limit pattern based on the output limit information received from the management device.

According to (1) to (7), it is possible to appropriately control the output of a battery to be secondarily used.

### BRIEF DESCRIPTION OF THE DRAWINGS

FIG. 1 is a diagram showing an example of a configuration of a control system according to an embodiment.

FIG. 2 is a diagram showing an example of information stored in a storage unit of a management device according to an embodiment.

FIG. 3 is a diagram showing an example of a configuration of a vehicle provided with a control device of an embodiment.

FIG. 4 is a diagram showing an example of configuration of a battery device according to an embodiment.

FIG. 5 is a diagram showing an example of configuration of a battery⋅VCU control section according to an embodiment.

FIG. 6 is a diagram showing an example of three-dimensional space model information.

FIG. 7 is a sequence diagram showing an example of a processing procedure of the control system according to an embodiment.

FIG. 8 is a diagram showing an example of output limit patterns.

FIG. 9 is a flowchart showing a processing procedure example of a first modification according to an embodiment.

FIG. 10 is a flowchart showing a processing procedure example of a second modification according to an embodiment.

FIG. 11 is a diagram showing an example of a margin model.

FIG. 12 is a diagram showing an example of a model.

### DESCRIPTION OF EMBODIMENTS

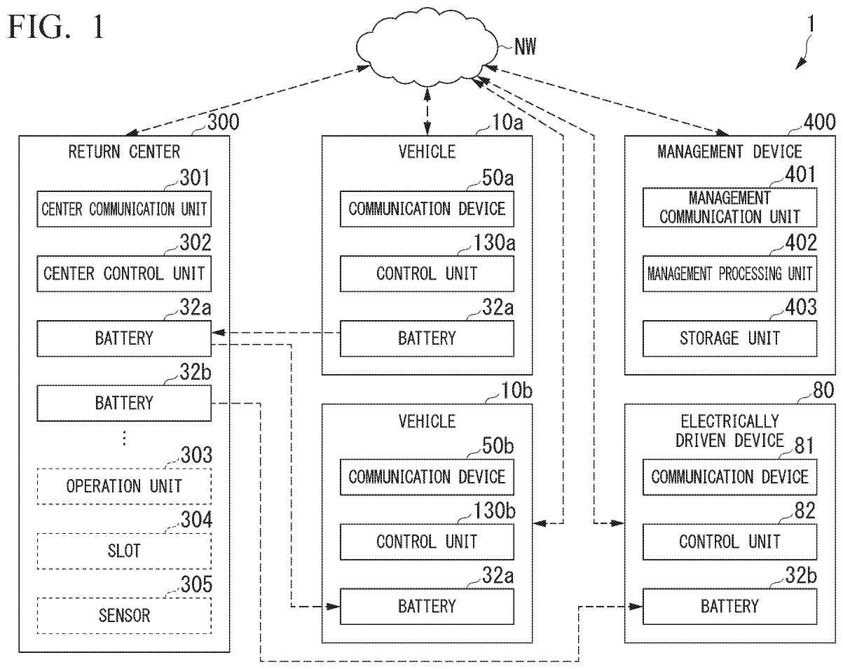

Hereinafter, embodiments of a control device, a control system, a control method, and a storage medium of the present invention will be described with reference to the drawings. FIG. 1 is a diagram showing an example of a configuration of a control system 1 according to the present embodiment.

First, a configuration example of the control system 1 will be described with reference to FIG. 1. As shown in FIG. 1, the control system 1 includes a vehicle 10a, a vehicle 10b, an electrically driven device 80, a return center 300, and a management device 400. The configuration example of FIG. 1 is an example and it is sufficient if the number of vehicles is one or more.

The vehicle 10a includes a communication device 50a, a control unit 130a, and a battery 32a.

The vehicle 10b includes a communication device 50b, a control unit 130b, and a battery 32a. In the example of FIG. 1, a battery mounted on the vehicle 10b is a battery mounted on the vehicle 10a and then returned to the return center 300 for secondary use.

The electrically driven device 80 includes a communication device 81, a control unit 82, and a battery 32b. In the example of FIG. 1, a battery mounted on the electrically driven device 80 is a battery returned to the return center 300 for secondary use.

In the following description, when one of the vehicle 10a and the vehicle 10b is not specified, it is referred to as a vehicle 10. When one of the communication device 50a and the communication device 50b is not specified, it is referred to as a communication device 50. When one of the control unit 130a and the control unit 130b is not specified, it is referred to as a control unit 130.

The return center 300 includes a center communication unit 301 and a center control unit 302. In the example of FIG. 1, the return center 300 stores the returned batteries 32a and 32b. When one of the battery 32a and the battery 32b is not specified, it is referred to as a battery 32. The return center 300 may include, for example, an operation unit 303 using a touch panel or a mechanical switch, a slot 304 into which the returned battery 32 is inserted, and a sensor 305 for detecting that the battery 32 has been inserted or taken out from the slot 304.

The management device 400 includes a management communication unit 401, a management processing unit 402, and a storage unit 403.

(Each Device and Vehicle of Control System 1)

Next, each device and vehicle provided in the control system 1 will be described.

First, the vehicle 10 will be described.

The vehicle 10 is an example of an electrically driven device using a battery and may be a vehicle such as an electric four-wheeled vehicle, a saddle type vehicle (electric two-wheeled vehicle), an electric automatic lawnmower, an electric bicycle, an electric tricycle, an electric kick skater, and the like.

The vehicle 10a communicates with the management device 400 via a network NW. The vehicle 10b communicates with the management device 400 via the network NW.

The battery 32 is an energy source, and is, for example, a battery such as a nickel hydrogen battery, a lithium ion secondary battery, and a sodium ion battery, which can be repeatedly charged or discharged, or a fuel cell. The battery 32 may be an assembled battery in which battery cells are integrated. The battery 32 in the present embodiment is secondarily used.

The communication device 50 transmits discharge limit line information indicating a discharge limit line or upper limit current line information indicating an upper limit current line to the management device 400 via the network NW according to the control of the control unit 130. Alternatively, the communication device 50 receives the discharge limit line information or the upper limit current line information from the management device 400 via the network NW according to the control of the control unit 130. The communication device 50 outputs the acquired discharge limit line information or upper limit current line information to the control unit 130. In the following description, when one of the discharge limit line information and the upper limit current line information is not specified, it is referred to as output limit information. The output limit information includes battery type information indicating the type of the battery 32 and battery identification information for identifying the battery 32.

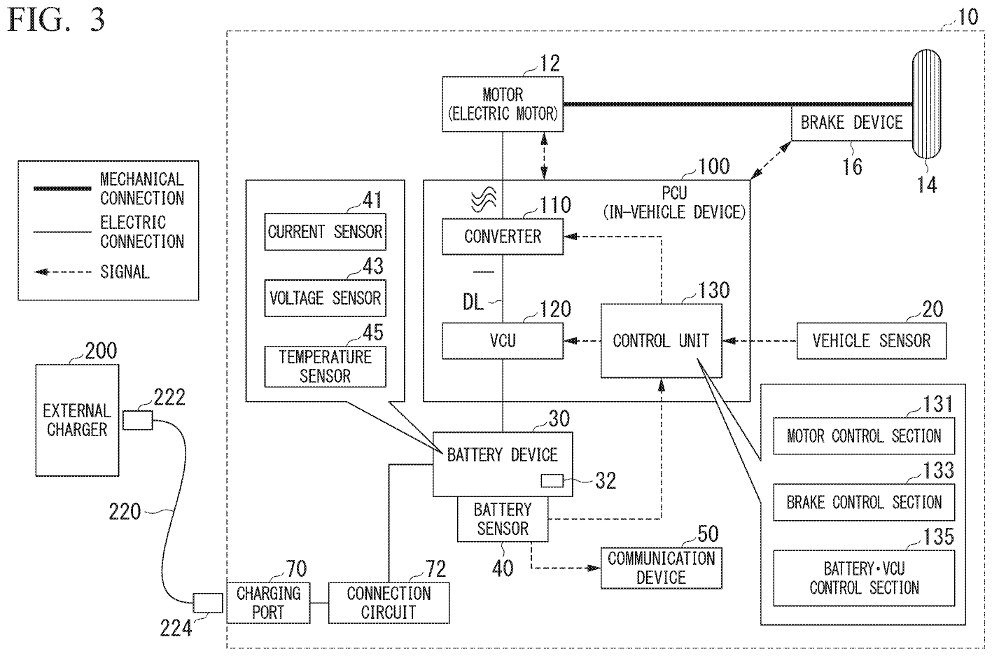

The control unit 130 controls the vehicle 10. The control unit 130 determines the type of the battery 32 on the basis of, for example, information stored in a storage unit included in the battery 32. The control unit 130 may estimate the type of the battery 32 on the basis of the current value, the voltage value, the temperature, the usage time, and the like of the battery 32. When the battery 32 is a secondary battery, the control unit 130 detects the discharge limit line information by a battery device 30 (see FIG. 3). When the battery 32 is a fuel cell, the control unit 130 detects the upper limit current line information by the battery device 30 (see FIG. 3). The control unit 130 controls the battery 32 by switching output limit patterns by using the received output limit information. The output limit patterns will be described below.

The electrically driven device 80 is the vehicle 10, a robot, and the like.

An operation of the communication device 81 is the same as that of the communication device 50. An operation of the control unit 82 is the same as that of the control unit 130.

Next, the return center 300 will be described.

The return center 300 collects the battery 32 exchanged or returned by a user of the vehicle 10 and stores the collected battery 32. The return center 300 rents or sells the returned battery 32. The return center 300 may be, for example, a sales place of the vehicle 10, a charging station of the battery 32, and the like. The return center 300 communicates with the management device 400 via the network NW.

The center communication unit 301 transmits collection date information indicating a collection date of the collected battery 32 to the management device 400 via the network NW according to the control of the center control unit 302. The center communication unit 301 transmits shipping date information, which indicates the date when the battery 32 has been rented or sold, to the management device 400 via the network NW according to the control of the center control unit 302. The collection date information and the shipping date information may include time information.

The center control unit 302 acquires the collection date information or the shipping date information. The collection date information or the shipping date information may be acquired on the basis of a result when a user of the center control unit 302 has operated the operation unit 303 provided in the return center 300. Alternatively, the collection date information or the shipping date information may be detected on the basis of the result when the sensor 305 detects that the battery 32 has been inserted into the slot 304 in which the battery 32 is stored, or taken out from the slot 304.

Next, the management device 400 will be described.

The management device 400 is, for example, a server device.

The management communication unit 401 receives the output limit information, which is transmitted by the vehicle 10, via the network NW, and outputs the received output limit information to the management processing unit 402. The management communication unit 401 receives the collection date information and the shipping date information, which are transmitted by the return center 300, via the network NW, and outputs the received collection date information and shipping date information to the management processing unit 402. The management communication unit 401 receives a request instruction (including battery identification information and identification information of the vehicle 10), which is transmitted by the vehicle 10, via the network NW, and outputs the received battery identification information to the management processing unit 402. The management communication unit 401 transmits the output limit information, which is output by the management processing unit 402, to the vehicle 10 that has transmitted the request instruction via the network NW.

The management processing unit 402 stores the output limit information received by the management communication unit 401 in the storage unit 403. The management processing unit 402 reads the output limit information, which is associated with the battery identification information included in the received request instruction, from the storage unit 403 when the management communication unit 401 has received the request instruction, and outputs the read output limit information to the management communication unit 401.

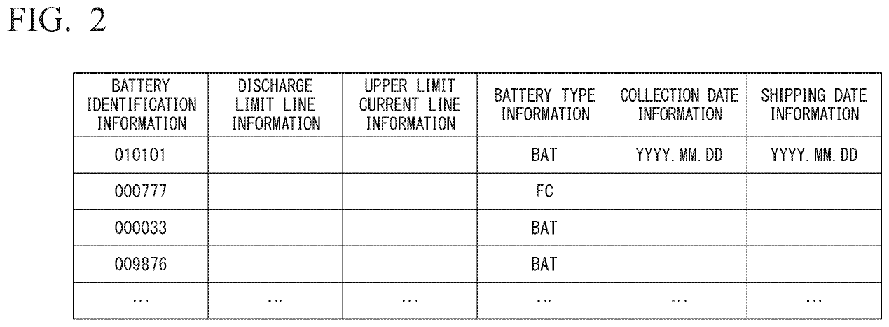

The storage unit 403 stores the information received from the vehicle 10. The information stored in the storage unit 403 will be described below with reference to FIG. 2.

(Information Stored in Storage Unit 403 of Management Device 400)

Next, an example of the information stored in the storage unit 403 of the management device 400 will be described.

FIG. 2 is a diagram showing an example of the information stored in the storage unit 403 of the management device 400 according to the present embodiment.

As shown in FIG. 2, the storage unit 403 stores the battery identification information in association with the discharge limit line information or the upper limit current line information, the battery type information, the collection date information, and the shipping date information. The information shown in FIG. 2 is an example, and other information (for example, a battery cell manufacturer, battery cell lot information, and the like) may also be associated and stored.

(Configuration Example of Vehicle Provided with Control Device)

Next, a configuration example of the vehicle provided with the control device will be described.

FIG. 3 is a diagram showing an example of a configuration of the vehicle 10 provided with the control device of the present embodiment. As shown in FIG. 3, the vehicle 10 includes, for example, a motor 12, a driving wheel 14, a brake device 16, a vehicle sensor 20, the battery device 30, a battery sensor 40, a communication device 50, a charging port 70, a connection circuit 72, and a power control unit (PCU) 100. The PCU 100 is an example of the control device.

The motor 12 is, for example, a three-phase AC motor. A rotor of the motor 12 is connected to the driving wheel 14. The motor 12 outputs power to the driving wheel 14 by using supplied electric power. The motor 12 generates electricity by using kinetic energy of the vehicle when the vehicle decelerates.

The brake device 16 includes, for example, a brake caliper, a cylinder for transferring hydraulic pressure to the brake caliper, and an electric motor for generating the hydraulic pressure in the cylinder. The brake device 16 may have a backup mechanism for transferring the hydraulic pressure generated by an operation of a brake pedal to the cylinder via a master cylinder. The brake device 16 is not limited to the aforementioned configuration and may be an electronically controlled hydraulic pressure brake device that transfers the hydraulic pressure of the master cylinder to the cylinder.

The vehicle sensor 20 includes, for example, an accelerator opening degree sensor, a vehicle speed sensor, and a brake depression amount sensor. The accelerator opening degree sensor is attached to an accelerator pedal, which is an example of an operator that receives an acceleration instruction from a driver, detects an operation amount of the accelerator pedal, and outputs the operation amount to the PCU 100 as an accelerator opening degree. The vehicle speed sensor includes, for example, a wheel speed sensor attached to each wheel and a speed calculator, integrates wheel speeds detected by the wheel speed sensors to derive the speed of the vehicle (vehicle speed), and outputs the speed of the vehicle to the PCU 100. The brake stepping amount sensor is attached to the brake pedal, detects an operation amount of the brake pedal, and outputs the operation amount to the PCU 100 as a brake stepping amount.

The PCU 100 includes, for example, a converter 110, a voltage control unit (VCU) 120, and the control unit 130. The converter 110 is, for example, an AC-DC converter (AC to DC converter). A DC-side terminal of the converter 110 is connected to a DC link DL. The battery device 30 is connected to the DC link DL via the VCU 120. The converter 110 converts an alternating current generated by the motor 12 into a direct current, and outputs the direct current to the DC link DL. The VCU 120 is, for example, a DC-DC converter (DC to DC converter). The VCU 120 boosts the power supplied from the battery device 30 and outputs the boosted power to the DC link DL.

The control unit 130 includes, for example, a motor control section 131, a brake control section 133, and a battery⋅VCU control section 135. The motor control section 131, the brake control section 133, and the battery⋅VCU control section 135 may be replaced with separate control devices, for example, control devices such as a motor ECU, a brake ECU, and a battery ECU, respectively. The control unit 130 controls the operation of each component of the vehicle 10 such as the converter 110, the VCU 120, and the battery device 30.

The control unit 130 is implemented by, for example, a hardware processor such as a central processing unit (CPU) executing a program (software). Some or all of these components may be implemented by hardware (a circuit unit: including circuitry) such as a large scale integration (LSI), an application specific integrated circuit (ASIC), a field-programmable gate array (FPGA), and a graphics processing unit (GPU), or may be implemented by software and hardware in cooperation.

The program may be stored in advance in a storage device (non-transitory storage medium) such as a hard disk drive (HDD) and a flash memory, or may be installed when a detachable storage medium (non-transitory storage medium) storing the program, such as a DVD and a CD-ROM, is mounted on a drive device.

The motor control section 131 controls the motor 12 on the basis of the output of the vehicle sensor 20. The brake control section 133 controls the brake device 16 on the basis of the output of the vehicle sensor 20.

The battery⋅VCU control section 135 controls the output of the battery device 30. For example, the battery⋅VCU control section 135 calculates the state of charge (SOC) of the battery 32 on the basis of the output of the battery sensor 40 attached to the battery 32 of the battery device 30, and outputs the SOC to the VCU 120. The VCU 120 increases the voltage of the DC link DL in response to an instruction from the battery⋅VCU control section 135. Details of the battery device 30 will be described below.

The battery sensor 40 includes, for example, a current sensor 41, a voltage sensor 43, a temperature sensor 45, and the like. The battery sensor 40 detects, for example, the current value, the voltage value, the temperature, and the like for charging and discharging the battery 32. The battery sensor 40 outputs the detected current value, voltage value, temperature, and the like to the control unit 130 and the communication device 50. The battery sensor 40 may be accommodated in a housing of the battery device 30 or may be attached to the housing. Hereinafter, the current value, the voltage value, the temperature, and the like detected by the battery sensor 40 will be referred to as battery parameters.

The communication device 50 includes a wireless module for connecting a wireless communication network such as a wireless LAN and a cellular network. The wireless LAN may be, for example, Wi-Fi (registered trademark), Bluetooth (registered trademark), or Zigbee (registered trademark). The cellular network may be, for example, a third generation mobile communication network (3G), a fourth generation mobile communication network (long term evolution: LTE (registered trademark)), a fifth generation mobile communication network (5G), and the like. The communication device 50 may acquire the current value, the voltage value, the temperature, and the like output from the battery sensor 40, and transmit them to an exterior.

The charging port 70 is provided oriented toward outside of a vehicle body of the vehicle 10. The charging port 70 is connected to an external charger 200 via a charging cable 220. The charging cable 220 includes a first plug 222 and a second plug 224. The first plug 222 is connected to the external charger 200 and the second plug 224 is connected to the charging port 70. The electricity supplied from the external charger 200 is supplied to the charging port 70 via the charging cable 220.

The charging cable 220 includes a signal cable attached to a power cable. The signal cable relays communication between the vehicle 10 and the external charger 200. Consequently, each of the first plug 222 and the second plug 224 is provided with a power connector and a signal connector.

The connection circuit 72 is provided between the battery device 30 and the charging port 70. The connection circuit 72 converts a current introduced from the external charger 200 via the charging port 70, for example, an alternating current into a direct current. The connection circuit 72 outputs the converted direct current to the battery device 30.

(Configuration Example of Battery Device 30)

Next, a configuration example of the battery device 30 will be described.

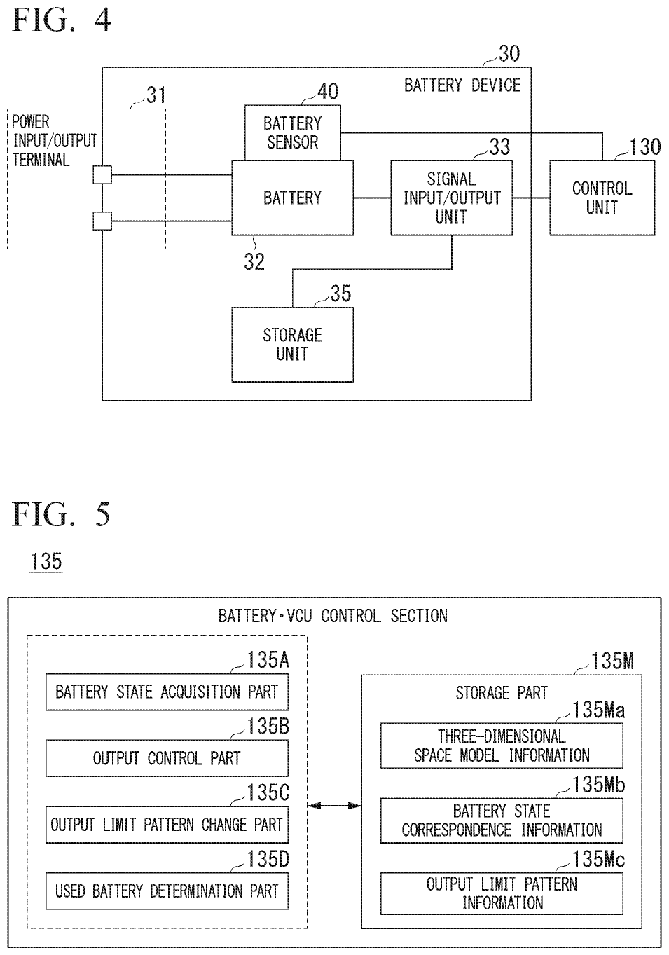

FIG. 4 is a diagram showing an example of a configuration of the battery device 30 according to the present embodiment. The battery device 30 of the present embodiment includes, for example, a power input/output terminal 31, the battery 32, a signal input/output unit 33, and a storage unit 35. These components are accommodated in, for example, one housing.

The battery device 30 is connected to a power system of the vehicle 10 via the power input/output terminal 31. The battery 32 stores the electric power supplied from the external charger 200, and performs discharging for traveling of the vehicle 10.

The signal input/output unit 33 is connected to the control unit 130 of the vehicle 10. The signal input/output unit 33 includes, for example, a signal terminal (connector) to which a plug and the like are connected. A security signal is input to the signal input/output unit 33. The signal input/output unit 33 is connected to the storage unit 35.

The storage unit 35 may be a storage device (non-transitory storage medium) such as a hard disk drive (HDD) and a flash memory, or may further include a control circuit that enables or disables writing of information to the storage device or reading of information from the storage device, in addition to the storage device such as the HDD and the flash memory. The storage unit 35 stores, for example, information on a power capacity value of the battery 32, an internal resistance value of the battery 32, SOC-OCV curve characteristics of the battery 32, and the like. The above information is written by the control unit 130 or read by the control unit 130.

Hereinafter, an operation of writing information to the storage unit 35 by the control unit 130 will be described. On the basis of the current value, the voltage value, the temperature, and the like detected by the battery sensor 40, the control unit 130 generates charging information of the battery device 30 and writes the charging information in the storage unit 35. The charging information includes, for example, the internal resistance value, the state of charge (SOC)-open circuit voltage (OCV) curve characteristics, the environmental temperature of the battery device 30, the capacity during full charging, and the like. The full charging is a state in which the capacity of a power storage unit 420 is fully charged at a predetermined time. The control unit 130 may perform the generation of the charging information of the battery device 30 and the writing of the charging information to the storage unit 35 at predetermined time intervals, for example, every minute, every hour, or every day, or on the basis of an instruction of the user of the vehicle 10.

(Configuration Example of Battery⋅VCU Control Section 135)

Next, a configuration example of the battery⋅VCU control section 135 will be described.

FIG. 5 is a diagram showing an example of a configuration of the battery⋅VCU control section 135 according to the present embodiment. The battery⋅VCU control section 135 of the present embodiment includes, for example, a battery state acquisition part 135A, an output control part 135B, an output limit pattern change part 135C, a used battery determination part 135D, and a storage part 135M. The storage part 135M stores, for example, three-dimensional space model information 135Ma, battery state correspondence information 135Mb, and output limit pattern information 135Mc.

The battery state acquisition part 135A, the output control part 135B, the output limit pattern change part 135C, and the used battery determination part 135D are implemented by, for example, a processor such as a CPU executing a program (software) stored in the storage part 135M. Some or all of these functional parts included in the battery⋅VCU control section 135 may be implemented by hardware (a circuit unit: including circuitry) such as an LSI, an ASIC, a FPGA, and a GPU, or may be implemented by software and hardware in cooperation. The program may be stored in advance in a storage device (non-transitory storage medium) such as an HDD and a flash memory, or may be installed when a detachable storage medium (non-transitory storage medium) storing the program, such as a DVD and a CD-ROM, is mounted on a drive device. The storage part 135M is implemented by the storage device described above.

For example, the battery state acquisition part 135A read the charging information from the storage unit 35 of the battery device 30 and acquires the battery state of the battery 32 on the basis of the read charging information. The battery state is information indicating the degree of deterioration that progresses according to the usage conditions of the battery 32, and is indicated by, for example, state levels indicating the degree of deterioration numerically. The state levels include, for example, state level R1, state level R2, state level R3, . . . in ascending order of deterioration degree of the battery 32.

For example, the battery state acquisition part 135A reads the power capacity value of the battery 32, the internal resistance of the battery 32, and the SOC-OCV curve characteristics of the battery 32 from the storage unit 35 as the charging information. The battery state acquisition part 135A refers to the three-dimensional space model information 135Ma stored in the storage part 135M and acquires coordinates of a three-dimensional space model indicated by the read charging information. The coordinates of the three-dimensional space model are correlated with the state level of the battery 32 in advance in, for example, the battery state correspondence information 135Mb stored in the storage part 135M. The battery state acquisition part 135A refers to the battery state correspondence information 135Mb stored in the storage part 135M and acquires the state level of the battery 32 on the basis of the derived coordinates.

The battery state acquisition part 135A may derive the charging information including the power capacity value of the battery 32, the internal resistance of the battery 32, and the SOC-OCV curve characteristics of the battery 32 on the basis of the detection results of the battery parameters (for example, the current value, the voltage value, the temperature, and the like) acquired from the battery sensor 40, and then acquire the battery state on the basis of the derived charging information.

The battery state acquisition part 135A may acquire the battery state on the basis of, for example, a transition (change) of the battery state defined in the three-dimensional space model. For example, the battery state acquisition part 135A may acquire the battery state on the basis of a transition from the coordinates of a three-dimensional space model based on the charging information read from the storage unit 35 of the battery device 30 to the coordinates of a three-dimensional space model based on the detection results of the battery parameters. The battery state acquisition part 135A may acquire the battery state on the basis of the transition between the coordinates of the three-dimensional space model based on the charging information read from the storage unit 35 of the battery device 30, or may acquire the battery state on the basis of the transition between the coordinates of the three-dimensional space model based on the detection results of the battery parameters.

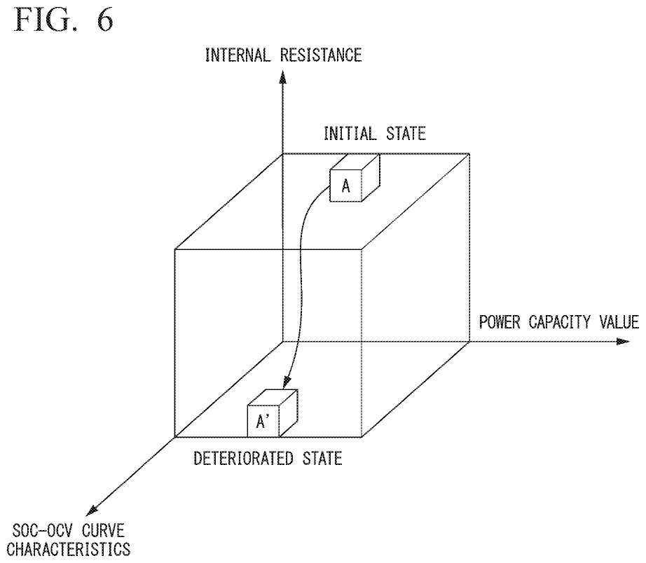

The three-dimensional space model information 135Ma is information for determining the battery state by using the three-dimensional space model. The three-dimensional space model information 135Ma is a space model defined in three-dimensions of the power capacity value of the battery, the internal resistance of the battery, and the SOC-OCV curve characteristics of the battery, for example. FIG. 6 is a diagram showing an example of the three-dimensional space model information 135Ma. In the three-dimensional space model information 135Ma, a transition curve in which the battery state transitions from an initial state A to a deteriorated state A′ is defined. This transition curve is determined in advance for each type of a battery and a product.

The battery state correspondence information 135Mb is, for example, information in which the coordinates of the three-dimensional space model information 135Ma are correlated with the state level of the battery. For example, the state level of the battery is correlated with a set of coordinates within a certain peripheral range including the transition curve shown in FIG. 6.

The output limit pattern information 135Mc includes, for example, a plurality of output limit patterns with different output levels. The output limit patterns are, for example, a set of upper limit values of output levels determined in advance according to an energization time. The output level may be, for example, an output power (W) of the battery 32, but is not limited thereto, and may be the amount of power (Wh) used for the vehicle 10 to travel.

The output control part 135B is a control part that controls the output of the battery 32. The output control part 135B controls the output of the battery 32 with reference to set output limit patterns. For example, the output control part 135B refers to the set output limit patterns, and limits the output of the battery 32 such that the output reaches an output level corresponding to the energization time at the time of control.

The output control part 135B writes, in the storage part 135M, information in which identification information indicating the set output limit patterns (hereinafter, referred to as output limit pattern ID) is correlated with the battery identification information of the battery 32. For example, the output control part 135B refers to the battery identification information stored in the storage part 135M, and determines that a different battery 32 has been installed when the battery identification information stored in the storage part 135M does not match the battery identification information read from the storage unit 35 of the battery device 30.

The output limit pattern change part 135C changes the output limit pattern referred to by the output control part 135B from an initial output limit pattern to an output limit pattern with a high output level on the basis of the battery state acquired by the battery state acquisition part 135A. When the output limit pattern is changed, the output limit pattern change part 135C rewrites an output control pattern ID correlated with the battery identification information.

The output limit pattern change part 135C transmits output limit information indicating an output limit pattern currently used for control to the management device 400 via the communication device 50.

Moreover, when the battery 32 is exchanged, the output limit pattern change part 135C changes an output limit pattern on the basis of output limit information received from the management device 400 when the battery 32 is a used battery.

The used battery determination part 135D determines whether the battery 32 mounted on the vehicle 10 is a used battery that has been secondarily used. For example, in a used battery, information indicating the used battery is written in the storage unit included in the battery 32 or is written in the storage unit 35 of the battery device 30. The used battery determination part 135D determines whether the mounted battery 32 is a new battery or a used battery on the basis of the information read from the storage unit 35 of the battery device 30.

(Example of Processing Procedure)

Next, an example of a processing procedure will be described.

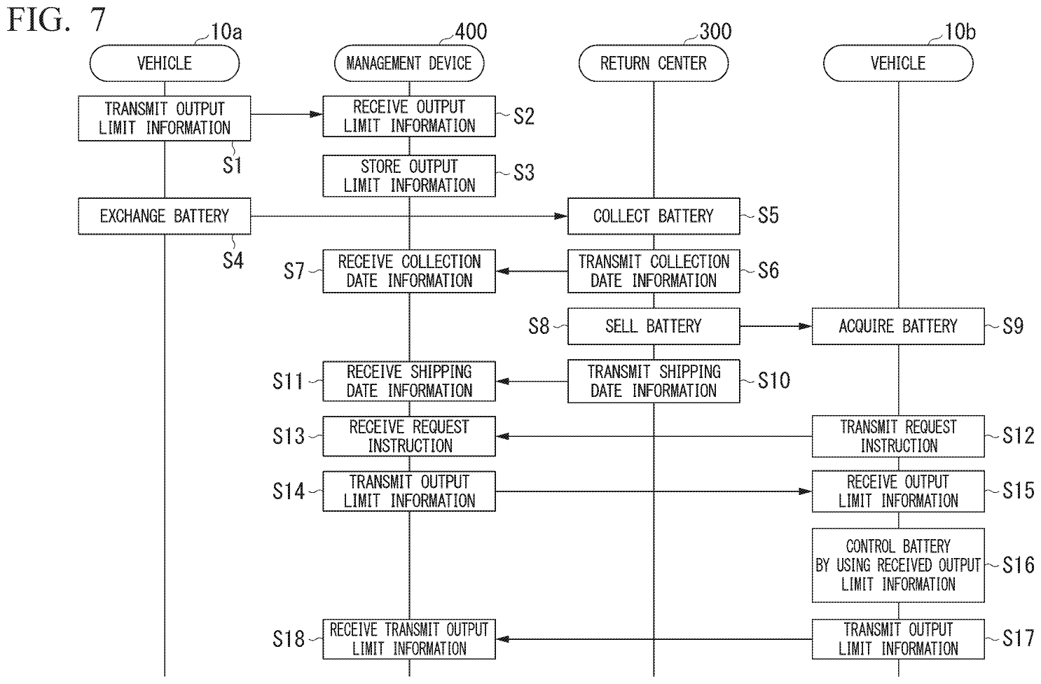

FIG. 7 is a sequence diagram showing an example of the processing procedure of the control system 1 according to the present embodiment.

The control unit 130a of the vehicle 10a transmits output limit information to the management device 400 via the communication device 50a (step S1).

The management processing unit 402 of the management device 400 receives the output limit information, which is transmitted by the vehicle 10a, via the management communication unit 401 (step S2), and stores the received output limit information in the storage unit 403 (step S3).

A user of the vehicle 10a returns the battery 32a mounted on the vehicle 10a to the return center 300, for example, in order to exchange the battery 32 (step S4). The center control unit 302 of the return center 300 collects the returned battery 32a (step S5), and transmits the battery identification information and the collection date information of the collected battery 32a to the management device 400 via the center communication unit 301 (step S6). The management processing unit 402 of the management device 400 receives the battery identification information and the collection date information, which are transmitted by the return center 300, via the management communication unit 401 (step S7).

The return center 300 sells, for example, the battery 32a to a user of the vehicle 10b (step S8). The user of the vehicle 10b acquires the battery 32a and mounts the battery 32a on the vehicle 10b (step S9). The center control unit 302 of the return center 300 transmits the shipping date information of the collected battery 32a to the management device 400 via the center communication unit 301 (step S10). The management processing unit 402 of the management device 400 receives the shipping date information, which is transmitted by the return center 300, via the management communication unit 401 (step S11).

The control unit 130b of the vehicle 10b detects whether the battery 32a mounted on the vehicle 10b is a used battery. When the battery 32a is a used battery, the control unit 130b acquires the battery identification information of the battery 32a mounted on the vehicle 10b, and transmits a request instruction (including battery identification information and identification information of the vehicle 10b) for requesting the transmission of output limit information to the management device 400 via the communication device 50b (step S12). The management processing unit 402 of the management device 400 receives the request instruction, which is transmitted by the vehicle 10b, via the management communication unit 401 (step S13).

The management processing unit 402 of the management device 400 reads the output limit information associated with the battery identification information included in the received request instruction from the storage unit 403, and transmits the read output limit information to the vehicle 10b via the management communication unit 401 (step S14). The control unit 130b of the vehicle 10b receives the output limit information, which is transmitted by the management device 400, via the communication device 50b (step S15). The control unit 130b of the vehicle 10b controls the battery 32a by using the received output limit information (step S16).

The control unit 130b of the vehicle 10b transmits the output limit information to the management device 400 via the communication device 50b (step S17).

The management processing unit 402 of the management device 400 receives the output limit information, which is transmitted by the vehicle 10b, via the management communication unit 401 (step S18), and stores the received output limit information in the storage unit 403.

When the battery 32 used in the vehicle 10b is reused by the processes of steps S17 and S18, the output limit information can be received from the management device 400 and used according to the present embodiment.

The processing example of FIG. 7 is an example; however, the present invention is not limited thereto. For example, the return center 300 may not transmit the collection date information. In such a case, the vehicle 10a may periodically (for example, every hour, every day, every week, and the like) transmit the output limit information to the management device 400, and the management device 400 may update the collection date information when the output limit information is received. With this, the management device 400 may determine the date, on which the output limit information has been transmitted before the battery 32a is returned, as a collection date.

The return center 300 may not transmit the shipping date information to the management device 400. In such a case, when the battery 32a is mounted on the vehicle 10b, a request instruction may be transmitted to the management device 400, and the management device 400 may determine a shipping date when the request instruction is received.

(Example of Output Limit Pattern Information)

Next, an example of output limit pattern information will be described.

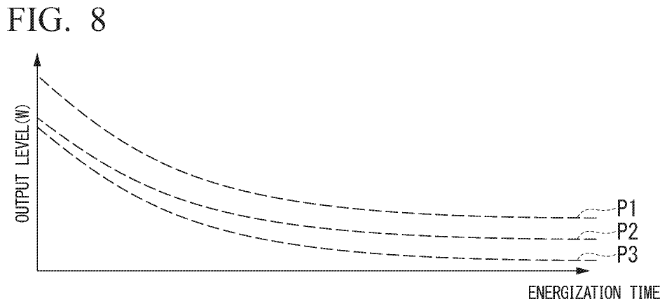

FIG. 8 is a diagram showing an example of output limit patterns. As shown in FIG. 8, each output limit pattern is a function indicated by an energization time on the horizontal axis and an output level (W) on the vertical axis. The output limit pattern information 135Mc includes, for example, a plurality of output limit patterns P1 to P3. Among them, the output limit pattern P1 has the highest output level at the same energization time. Among them, the output limit pattern P3 has the lowest output level at the same energization time. The output limit pattern P1 having the highest output level is a pattern in the case of a new battery, and the output of the battery 32 is not limited.

(First Modification)

In the example shown in FIG. 7, an example in which the output limit information received from the management device 400 is used when the battery 32 is exchanged has been described; however, the present invention is not limited thereto. It may take some time for the battery 32 to be used after being returned and deterioration may progress. Therefore, in the first modification, a margin is added to the received output limit information and used. For example, in FIG. 8, the difference between P3 and P2 is the margin. When P3 is an output limit pattern based on the output limit information, the control unit 130 changes the output limit pattern to P2 on the basis of a storage period and the like.

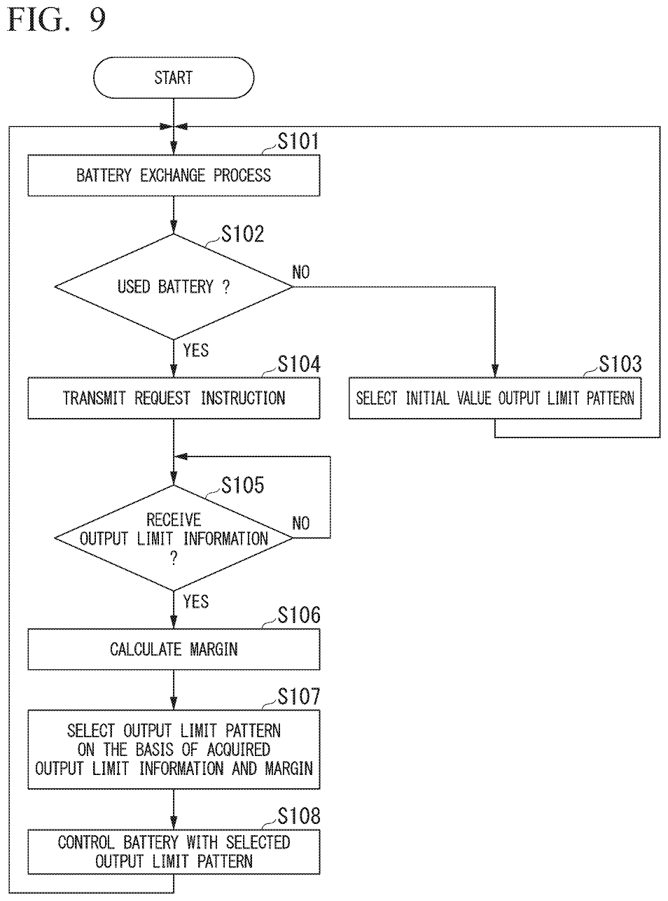

FIG. 9 is a flowchart showing a processing procedure example of the first modification according to the present embodiment. The following process is performed by the control unit 130b of the vehicle 10b.

The control unit 130b of the vehicle 10b acquires battery identification information from the battery 32 when the battery 32 is exchanged, and acquires information regarding whether the battery 32 is a used battery that has been secondarily used (step S101). On the basis of the acquired information regarding whether the battery 32 is a used battery that has been secondarily used, the control unit 130b determines whether the exchanged battery 32 is a used battery (step S102).

When it is determined that the exchanged battery 32 is not a used battery (step S102: NO), the control unit 130b selects an initial value output limit pattern because the exchanged battery 32 is a new battery (step S103). After the process, the control unit 130b returns the procedure to step S101.

When it is determined that the exchanged battery 32 is a used battery (step S102: YES), the control unit 130b transmits a request instruction to the management device 400 (step S104).

The control unit 130b determines whether it is possible to receive output limit information in response to the transmitted request instruction (step S105).

When it is determined that it is possible to receive the output limit information (step S105: YES), the control unit 130b calculates or determines a margin (step S106). The control unit 130b calculates or determines the margin on the basis of collection date information and shipping date information included in the received output limit information. The control unit 130b adds the calculated margin (predetermined margin) to the received output limit information and selects an output limit pattern (step S107), and controls the battery 32 with the selected output limit pattern (step S108). After the process, the control unit 130b returns the procedure to step S101.

When it is determined that it is not possible to receive the output limit information (step S105: NO) or when it is not possible to transmit the request instruction to the management device 400, the control unit 130b repeats the process of step S105.

In the aforementioned example, an example in which the margin is calculated by the vehicle 10 side has been described; however, the management device 400 may calculate the margin and the margin may be transmitted in association with the output limit information. The margin may be added according to an elapsed time instead of being calculated. For example, a predetermined margin may be added when the elapsed time exceeds one month.

According to the present embodiment, even when it takes some time for the battery 32 to be used after being returned, it is possible to determine an output limit pattern in consideration of the elapsed period. By such processing, the control unit 130 can use the battery 32 with an output limit pattern suitable for the battery 32.

(Second Modification)

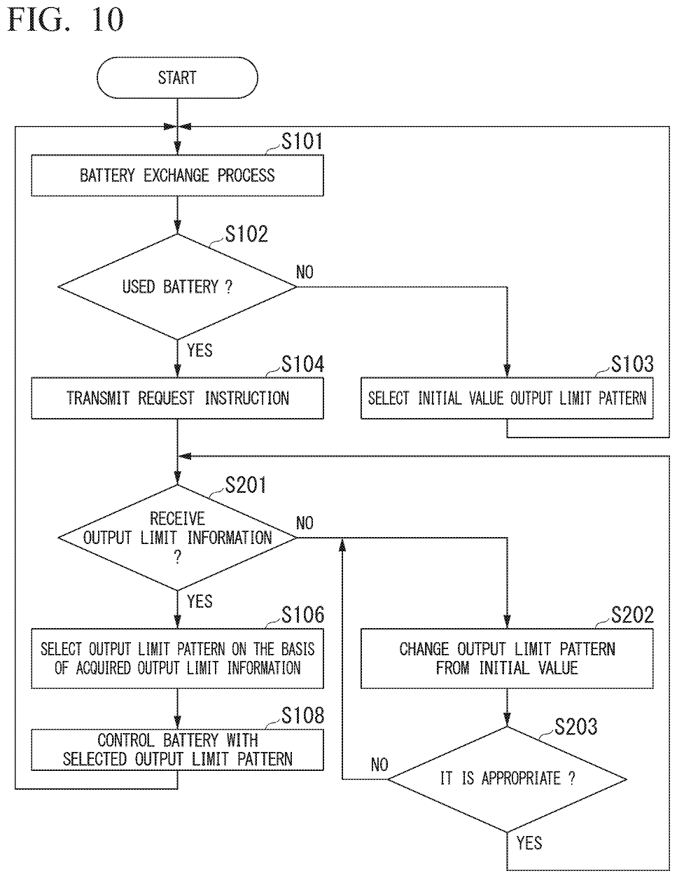

In the example shown in FIG. 7, an example in which it is possible to receive the output limit information from the management device 400 when the battery 32 is exchanged has been described; however, depending on communication environments and the like, it may not be possible to receive the output limit information when the battery 32 is exchanged. FIG. 10 is a flowchart showing a processing procedure example of the second modification according to the present embodiment. The following process is performed by the control unit 130b of the vehicle 10b. The same processes as those of the first modification (FIG. 9) are denoted by the same reference numerals and description thereof will be omitted.

The control unit 130b of the vehicle 10b performs the processes of steps S101 to S104 as in the first modification.

The control unit 130b determines whether it is possible to receive output limit information in response to the transmitted request instruction (step S201).

When it is determined that it is possible to receive the output limit information (step S201: YES), the control unit 130b selects an output limit pattern on the basis of the received output limit information (step S106), and controls the battery 32 with the selected output limit pattern (step S108). After the process, the control unit 130b returns the procedure to step S101.

When it is determined that it is not possible to receive the output limit information (step S201: NO) or when it is not possible to transmit the request instruction to the management device 400, the control unit 130b changes the output limit pattern from an initial value by, for example, one step (step S202). The control unit 130b determines whether the changed output limit pattern is appropriate, on the basis of information received by the battery device 30 (step S203).

When it is determined that the changed output limit pattern is appropriate (step S203: YES), the control unit 130b returns the procedure to the process of step S201. When it is determined that the changed output limit pattern is not appropriate (step S203: NO), the control unit 130b returns the procedure to the process of step S202.

As shown in FIG. 10, for example, even when it is not possible to receive the output limit information when the battery 32 is exchanged and the output limit pattern is switched and used, the control unit 130 can communicate to receive the output limit information, and then switches with the receivable output limit information and controls the battery 32.

Also in the present modification, a margin may be calculated in the same manner as in the first modification, and the battery 32 may be controlled on the basis of the calculated margin and the output limit information.

In the second modification, the control unit 130b of the vehicle 10b may switch the output limit pattern by using the output limit information received when it is possible to receive the output limit information when the battery 32 is exchanged, and may gradually change the output limit pattern when it is not possible to receive the output limit information. By such processing, the control unit 130 can use the battery 32 with an output limit pattern suitable for the battery 32.

(Third Modification)

In the first modification, an example in which the margin is calculated according to the storage period of the battery 32 has been described; however, the present invention is not limited thereto. The control unit 130b may calculate the margin on the basis of storage state information of the battery 32 after being collected. The storage state information of the battery 32 is, for example, storage temperature, capacity charged at the time of storage, and the like. The control unit 130 may estimate the margin by using, for example, a margin model that is stored in the storage part 135M.

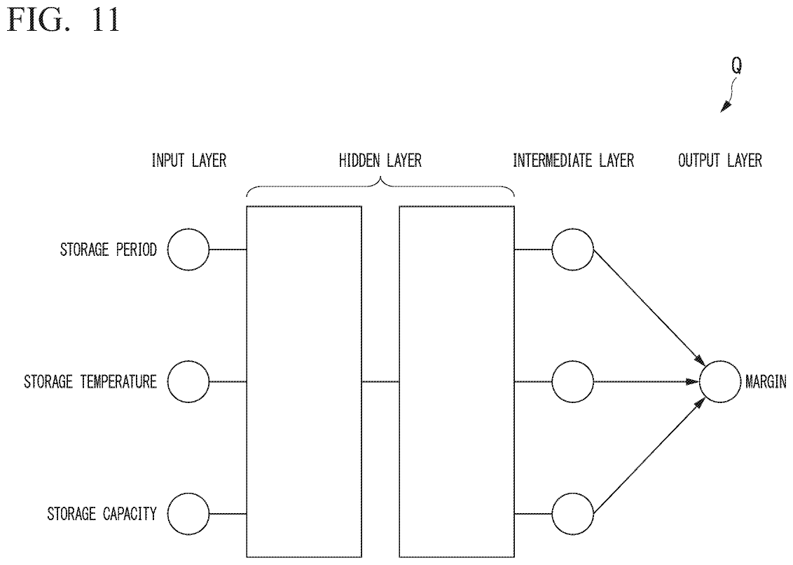

FIG. 11 is a diagram showing an example of a margin model Q. As shown in FIG. 11, the margin model Q has an input layer, a hidden layer, and an output layer. The hidden layer of the margin model Q includes, for example, one or more convolution neural networks (CNNs). The CNN includes a convolution layer (Cony) and a pooling layer (Pool). For example, a storage period (=shipping date-collection date), storage temperature, and storage capacity are input to the input layer of the margin model Q as input information. The output layer of the margin model Q is, for example, fully connected to an intermediate layer and outputs a margin. Parameters of the hidden layer are optimized by performing machine learning using input to the input layer as learning data and data, which is to be output from the intermediate layer or the output layer, as teacher data.

The control unit 130 may update the margin model Q by inputting the storage period, the storage temperature, and the storage capacity to the input layer and performing machine learning.

With this, according to the present modification, it is possible to accurately estimate the margin. Furthermore, the control unit 130 can select an output limit pattern on the basis of the margin estimated in this way and received output limit information, thereby using the battery 32 with an output limit pattern suitable for the battery 32.

(Fourth Modification)

The control unit 130 may estimate the type, SOC, and output of the battery 32 by using a model generated on the basis of the current value, the voltage value, the temperature, the usage time, and the like of the battery 32.

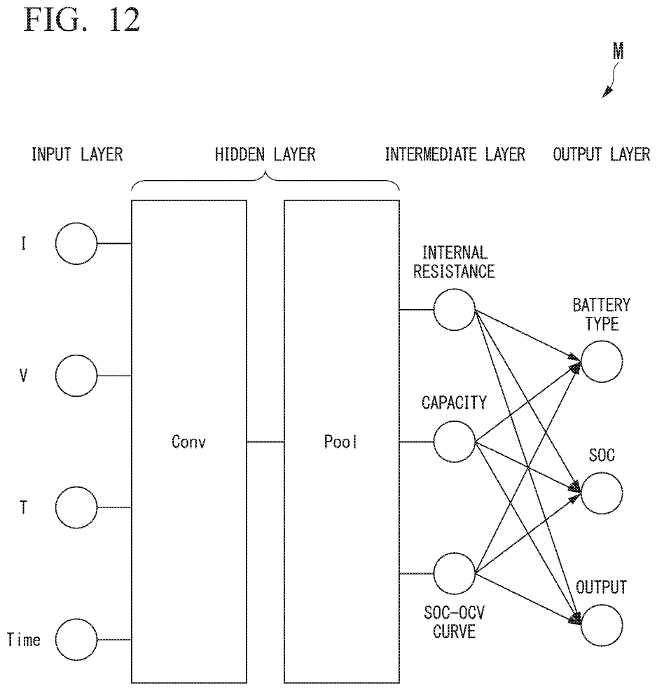

FIG. 12 is a diagram showing an example of a model M. As shown in FIG. 12, the model M has an input layer, a hidden layer, and an output layer. The model M is stored in the storage part 135M. The hidden layer of the model M includes, for example, one or more CNNs. The CNN includes a convolution layer (Cony) and a pooling layer (Pool). The current (I), voltage (V), temperature (T), and lifetime elapsed time (Time) of the battery 32 are input to the input layer of the model M as input information. The lifetime elapsed time is the time elapsed after the battery 32 is manufactured. An intermediate layer of the model M outputs the internal resistance, capacity, and SOC-OCV (open circuit voltage) curve of the battery 32 as output information. The output layer of the model M is, for example, fully connected to the intermediate layer and outputs the battery type, SOC, and output as presentation information. Parameters of the hidden layer are optimized by performing machine learning using input to the input layer as learning data and data, which is to be output from the intermediate layer or the output layer, as teacher data.

The control unit 130 may update the model M by inputting the current, voltage, temperature, and lifetime elapsed time of the battery 32 to the input layer and performing machine learning.

With this, according to the present modification, it is possible to accurately estimate the battery type, the SOC, and the output. Furthermore, the control unit 130 can select an output limit pattern on the basis of the information estimated in this way, thereby using the battery 32 with an output limit pattern suitable for the battery 32.

Although a mode for carrying out the present invention has been described using the embodiments, the present invention is not limited to these embodiments and various modifications and substitutions can be made without departing from the spirit of the present invention.

What is claimed is:

1. A control device comprising:
a communication unit configured to communicate with a management device that stores output limit information of an energy source used by a control device of a vehicle when the energy source is mounted on the vehicle; and
a control unit configured to control output of the energy source on the basis of an output limit pattern based on the output limit information received by the communication unit from the management device.

2. The control device according to claim 1, wherein the control unit controls the output of the energy source with an output limit pattern, in which a predetermined margin is added to the output limit pattern based on the output limit information, on the basis of information on the energy source.

3. The control device according to claim 2, wherein the control unit selects the margin on the basis of storage state information of the energy source.

4. The control device according to claim 1, further comprising:
an acquisition part configured to acquire a state of the energy source,
wherein, when the communication unit does not receive the output limit information from the management device, the control unit controls the output of the energy source mounted on the vehicle with reference to one output limit pattern of a plurality of output limit patterns with different output levels, and changes the output limit pattern from an initial output limit pattern to an output limit pattern with a high output level on the basis of the acquired state of the energy source.

5. A control system comprising:
a first electrically driven device including a first communication unit configured to transmit, to a management device, output limit information of an energy source used by a control device of a host vehicle when the energy source is mounted on the host vehicle;
a second electrically driven device including a control unit configured to transmit a transmission request of the output limit information of the energy source to the management device by using a second communication unit when the energy source is mounted, and to control output of the energy source on the basis of an output limit pattern based on the output limit information received by the second communication unit from the management device; and
the management device configured to store the output limit information received from the first electrically driven device, and to transmit the output limit information to the second electrically driven device when the transmission request of the output limit information is received from the second electrically driven device.

6. A control method implemented by a computer that:
communicates with a management device that stores output limit information of an energy source used by a control device of a vehicle when the energy source is mounted on the vehicle; and
controls output of the energy source on the basis of an output limit pattern based on the output limit information received from the management device.

7. A non-transitory computer readable storing medium storing a program causing a computer to:
communicate with a management device that stores output limit information of an energy source used by a control device of a vehicle when the energy source is mounted on the vehicle; and
control output of the energy source on the basis of an output limit pattern based on the output limit information received from the management device.
